(19) United States
(12) Patent Application Publication
(10) Pub. No.: US 2006/0029014 A1
(43) Pub. Date: Feb. 9, 2006

(54) System and method for establishing dynamic home agent addresses and home addresses using the mobile IPv6 protocol

(76) Inventor: Jagadish Maturi, San Diego, CA (US)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/911,109

(22) Filed: Aug. 4, 2004

(51) Int. Cl. H04Q 7/00

(52) U.S. Cl. 370/328; 370/400

(57) ABSTRACT

Provided are improved systems and methods for establishing dynamic Home Agent (HA) addresses and Home Addresses (HoA) for mobile stations operating on Foreign Networks according to the Mobile IPv6 standard, thereby providing the ability to dynamically assign IP addresses for mobile stations within a Home Network rather than using static or pre-provisioned IP addresses. The present invention provides new Type 7 Router Solicitation and Type 8 Router Advertisement messages to modify the existing Mobile IPv6 standard. The Type 7 and Type 8 messages enhance Mobile IPv6 to permit a mobile station in a Foreign Network to obtain through the Foreign Network a dynamically assigned Home Agent (HA) address and Home Address (HoA) from the Home Network for the mobile station.

### FIELD OF THE INVENTION

The present invention relates generally to mobile Internet Protocol (IP) communications and, more particularly, to systems and methods for dynamically determining Home Agent (HA) addresses and Home Address (HoA) for mobile stations in foreign networks operating according to a Code Division Multiple Access (CDMA) architecture.

### BACKGROUND

Internet Protocol (IP) addressing has previously been defined by a 32-bit standard commonly referred to as Internet Protocol Version 4 (IPv4 or IPv4 protocol). Recently, as more Internet users and devices have proliferated, the limitations of IPv4 have produced a need for a larger network space defined by a next generation Internet protocol. A 128-bit IP addressing standard, the Internet Protocol Version 6 (IPv6 or IPv6 protocol), has been developed to achieve this need for increased network space. Specifically, IPv6 defines a larger network space by exponentially increasing the number of available IP addresses available for use, such as available for assigning an IP address to each device on the IP network, including mobile IP devices. IPv6 includes a 64-bit top-order addressing layer to identify the subnet and a 64-bit lower-order addressing layer to identify the interface for the IP address space.

Just as a Mobile IP standard was developed for operating mobile stations on IPv4, the new IPv6 standard has produced a Mobile IPv6 for use with the IPv6 standard. Mobile IP and Mobile IPv6 are standards which provide architectures for operating a mobile station within an IP network. For example, Mobile IPv6 provides standards for achieving a communication link between a mobile station and an IPv6 network.

Currently, a Home Agent (HA) and a Home Address (HoA) are statically assigned, or pre-provisioned, to a mobile station by the Home Network of the mobile station. Thus, if the mobile station roams from its Home Network into a Foreign Network, the mobile station knows its HA address and HoA before leaving the Home Network because this information has been provided to the mobile station by the Home Network, such as where the HA address and HoA are stored in memory of the mobile station. Also, if the Home Network statically assigns, or pre-provisions, the HA address and HoA, such as when the Home Network allocates a particular IPv6 address space for the mobile station, the mobile station can take that information and use it when operating in a Foreign Network, including booting up in a Foreign Network. However, if the HA address and HoA are dynamically assigned by the Home Network, then the mobile station would not know that information when booting up for a first time in a Foreign Network. Currently, there is no mechanism within Mobile IPv6 for dynamically determining the HA address and HoA when booting up in a Foreign Network, such as for the first time or after extended non-operation in its Home Network such that its known HA address and/or HoA may have changed or expired.

Accordingly, there is a need in the art for an improved Mobile IPv6 standard including a system and method for dynamically determining Home Agent (HA) addresses and Home Address (HoA) for mobile stations in Foreign Networks.

### SUMMARY

In light of the foregoing background, embodiments of the present invention provide improved systems and methods for dynamically determining Home Agent (HA) addresses and Home Address (HoA) for mobile stations in Foreign Networks, thereby providing the ability to dynamically assign IP addresses for mobile stations within a Home Network rather than using static or pre-provisioned IP addresses. By way of example, the present invention provides a way to obtain the Home Agent (HA) address and Home Address (HoA) for a mobile station dynamically from a target Packet Data Serving Node (PDSN) using the AAA infrastructure and the Mobile IPv6 standard using Router Solicitation and Router Advertisement messages which have been enhanced in accordance the present invention. The present invention provides an enhancement to the existing Mobile IPv6 standard which permits dynamic addressing by defining Type 7 and Type 8 messages to request and transmit HA address and HoA data, respectively, for a mobile station.

An embodiment of a method for establishing dynamic home addressing of a mobile device may include the steps of establishing communications in a Foreign Network, sending an initiation message for home addressing data to a first network node of the Foreign Network, and receiving home addressing data from a second network node of the Foreign Network. The first and second network nodes may be the same network node on the Foreign Network. At least one of the steps of establishing communications and sending an initiation message comprises the steps of transmitting Home Network data to the Foreign Network. The step of sending initiation message may include the step of providing a request for at least one of a Home Agent (HA) address and a Home Address (HoA) and the step of receiving home addressing data may include the step of comprising at least one of a Home Agent (HA) address and a Home Address (HoA). The step of establishing communications may be performed according to the Mobile IPv6 standard. The step of sending an initiation message may include the step of sending a Router Solicitation message and the step of receiving home addressing data may include the step of receiving a Router Advertisement message including the requested home addressing data. The Router Solicitation message may include a Type 7 message and the Router Advertisement message may include a Type 8 message. This step of establishing communications may include the step of receiving a Care of Address for operation in the Foreign Network.

An embodiment of a method for establishing dynamic home addressing for mobile communications of the present invention may include the steps of establishing communications for a mobile station in a Foreign Network, sending an initiation message for home addressing data from the mobile station to a network node of the Foreign Network, acquiring home addressing data for the mobile station, and transmitting home addressing data from the network node to the mobile station. The step of establishing communications may be performed between the mobile station and the network node. The step of acquiring home addressing data may include the step of communicating between the Foreign Network and a Home Network for the mobile station. The step of acquiring home addressing data may include the step of communicating between the Foreign Network and a home addressing registry populated by a Home Network for the mobile station. At least one of the steps of establishing communications and sending an initiation message may include the step of transmitting Home Network data from the mobile station to the Foreign Network. The step of sending an initiation message may include the step of providing a request for at least one of a Home Agent (HA) address and a Home Address (HoA) and the step of transmitting home addressing data may include the step of transmitting at least one of a Home Agent (HA) address and a Home Address (HoA). The step of establishing communications may be performed according to the Mobile IPv6 standard. The step of sending an initiation message may include the step of sending a Router Solicitation message and the step of transmitting home addressing data may include the step of transmitting a Router Advertisement message including the requested home addressing data.

A system capable of establishing dynamic home addressing of an embodiment of the present invention may include a Home Network, a mobile station associated with the Home Network, and a Foreign Network wirelessly communicable with the mobile station and capable of dynamically providing home addressing data to the mobile station. The mobile station may be capable of transmitting Type 7 home addressing request messages to the Foreign Network and receiving Type 8 home addressing data messages from the Foreign Network. The Foreign Network may include an enhanced network node capable of receiving Type 7 home addressing request messages and transmitting Type 8 home addressing data messages. The enhanced network node may be a PDSN operating according to Mobile IPv6 enhanced to receive Type 7 home addressing request messages and transmit Type 8 home addressing data messages. The Home Network may include a network node capable of dynamically providing home addressing data for the mobile station to the Foreign Network. An embodiment of the system capable of establishing dynamic home addressing of the present invention may also include a home addressing registry communicable with the Home Network and the Foreign Network and capable of receiving home addressing data for the mobile station from the Home Network and providing the home addressing data for the mobile station to the Foreign Network.

These characteristics, as well as additional details, of the present invention are further described herein with reference to these and other embodiments.

### BRIEF DESCRIPTION OF THE DRAWING(S)

Having thus described the invention in general terms, reference will now be made to the accompanying drawings, which are not necessarily drawn to scale, and wherein:

FIG. 1 is a block diagram of one type of mobile station and system that would benefit from embodiments of the present invention;

FIG. 2 is a control flow diagram illustrating message call flow for Mobile IPv6 using pre-provisioned (static) Home Addresses and Home Agent Addresses;

FIG. 3 is a control flow diagram illustrating a message call flow for Mobile IPv6 using dynamic Home Addresses and Home Agent Addresses of an embodiment of the present invention;

FIG. 4 is a block diagram of the standard option format for a message in the Mobile IPv6 protocol standard;

FIG. 5 is a block diagram of a Type 7 Router Solicitation message for enhancing Mobile IPv6 according to an embodiment of the present invention;

FIG. 6 is a block diagram of a Type 8 Router Advertisement message for enhancing Mobile IPv6 according to an embodiment of the present invention;

FIG. 7 is a schematic block diagram of an entity capable of operating as a mobile station, network node, or a Home Agent of an embodiment of the present invention; and

FIG. 8 is a schematic block diagram of a mobile station capable of operating in accordance with dynamic addressing of an embodiment of the present invention.

### DETAILED DESCRIPTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

While a primary use of the present invention may be in the field of mobile phone communications, it will be appreciated from the following description that the invention is also useful for various other types of wireless IPv6 communication other than mobile phone communications. Further, while a primary use of mobile stations of the present invention may be in the field of mobile phone technology, it will be appreciated from the following that many types of devices that are generally referenced herein as mobile stations, including, for example, mobile phones, pagers, handheld data terminals and personal data assistants (PDAs), portable personal computer (PC) devices, electronic gaming systems, global positioning system (GPS) receivers, satellites, and other portable electronics, including devices that are combinations of the aforementioned devices may be used with the present invention. Further, while embodiments of the present invention are described with reference to Mobile IP protocol for CDMA architecture using AAA infrastructure for IPv6, the present invention may be used by alternate embodiments for other wireless communication architectures which function to operate a mobile station within a Home Network and assign the mobile station to Home Agents and/or Home Addresses, or similar unique addressing for mobile stations, to operate in Foreign Networks.

A Home Network typically refers to the primary service provider of the mobile stations such as a mobile telecommunications and services provider such as Verizon, Sprint, and AT&T. Similarly, a Home Agent (HA) typically refers to a router which provides connectivity for a mobile station to all the nodes in the Home Network and which may also maintain the binding between a Care-of-Address (COA) provided by a Foreign Network to the mobile station and a Home Address (HoA) assigned by the Home Network for the mobile station. A Foreign Network also refers to a Visiting Network. A Home Address (HoA) typically refers to an actual IP address which represents an IP space, such as the IP space defined for a mobile station. A Care-of-Address (COA) typically refers to an IP address through which a mobile station actually communicates on a Foreign Network. A Care-of-Address (COA) typically is defined as the global IPv6 address corresponding to a 64-bit Foreign Network prefix or subnet identifier on top of a 64-bit mobile IP address or interface identifier. AAA typically refers to authentication, authorization, and accounting and is typically used to refer to the AAA infrastructure where servers may be referred to as AAA servers such as a Visited AAA server and a Home AAA server.

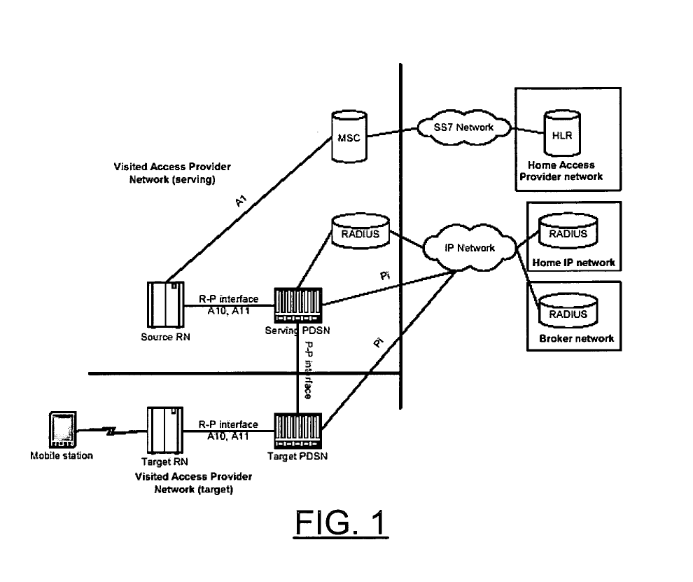

Referring now to FIG. 1, an illustration of one type of system that would benefit from the present invention is provided. As shown, the system can include a mobile station (MS) capable of transmitting signals to and receiving signals from base sites or base stations (BS) such as a Target RN of a Visited Access Provider Network (Target) connected to a Target PDSN. The Target RN and Target PDSN may be a part of a larger Visited Access Provider Network which includes serving systems such as a serving PDSN, a source RN, a Remote Authentication Dial In User Service (RADIUS), a Mobile Switching Center (MSC), and a Visitor Location Register (VLR, note shown). The Visited Access Provider Network may be connected to a Home Location Register (HLR) of a Home Access Provider Network through a Signaling System 7 (SS7) network. The Visited Network Provider Network may also be connected to a Broker Network RADIUS and a Home IP Network RADIUS through an IP network. In such a manner, the mobile station may be coupled to an IP network such as an IPv6 network and a Home IP Network such as a Home IPv6 Network. Although shown as separate entities, in some embodiments, one or more entities may support one or more of a Target, Serving Source, and Home RN, PDSN, and RADIUS server, an MSC, a VLR, an HLR, and other network nodes of a Visited or Home Access Provider network logically separated but co-located within the same entit(ies).

It should also be appreciated that the mobile station may be coupled to one or more of any number of different networks. In this regard, mobile networks can be capable of supporting communication in accordance with any one or more of a number of second-generation (2G), 2.5G, and/or third-generation (3G) mobile communication protocols or the like. Additionally or alternatively, mobile networks can be capable of supporting communication in accordance with any number of different wireless networking techniques, including WLAN techniques such as IEEE 802.11, WiMAX techniques such as IEEE 802.16 or the like. More particularly, for example, the mobile station can be coupled to one or more networks capable of supporting communication in accordance with 2G wireless communication protocols IS-136 (TDMA), GSM, and IS-95 (CDMA). Also, for example, one or more of the networks(s) can be capable of supporting communication in accordance with 2.5G wireless communication protocols GPRS, Enhanced Data GSM Environment (EDGE), or the like. In additional, for example, one or more of the networks can be capable of supporting communication in accordance with 3G wireless communication protocols such as Universal Mobile Telephone System (UMTS) network employing Wideband Code Division Multiple Access (WCDMA) radio access technology. Further, one or more of the network(s) can be capable of supporting enhanced 3G wireless communication protocols such as 1XEV-DO (TIA/EIA/1S-856) and 1XEV-DV.

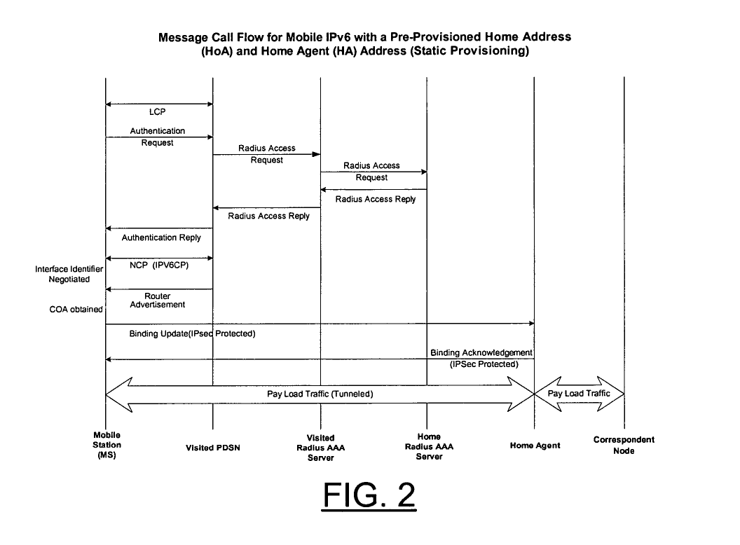

Referring now to FIG. 2, a control flow diagram is provided for Mobile IPv6 with a pre-provisioned Home Address (HoA) and Home Agent (HA) address, i.e., static provisioning. When a device starts up on a Foreign Network, such as a mobile station booting up for the first time in a Foreign Network operating in accordance with the CDMA 2000 architecture, the mobile device may initiate a point-to-point protocol (PPP) which begins with negotiating a link control protocol (LCP) between the mobile station and the Visited PDSN. The LCP negotiates various parameters such as the maximum packet size and other parameters which are defined in the PPP protocol as part of the initial phase of the PPP setup. Once the LCP has been negotiated, the second phase of the PPP setup is an authentication phase which includes an authentication request from the mobile station to the Visited PDSN, a RADIUS access request between the Visited PDSN and the Visited RADIUS AAA server, a RADIUS access request between the Visited RADIUS AAA server and the Home RADIUS AAA server, a RADIUS access reply from the Home RADIUS AAA server to the Visited RADIUS AAA server, a RADIUS access reply from the Visited RADIUS AAA server to the Visited PDSN, and an authentication reply from the Visited PDSN to the mobile station. The authentication of PPP includes passing Network Address Information (NAI) associated with the mobile station, or mobile user, to the Foreign Network such as a username@sprint.com representing a unique identification in the Home Network for the mobile station, or mobile user. The third phase of the PPP setup is the network control protocol (NCP) which typically is IPCP for an IPv4 initiation and IPv6CP for IPv6 initiation. The NCP negotiates the final phase of the PPP which establishes the negotiation for an interface identifier, or the lower 64 bits of the IPv6 address which is also referred to as the mobile IP address. Once the interface identifier has been negotiated through the PPP setup, a Router Advertisement is provided from the Visited PDSN to the mobile station. The Router Advertisement provides the subnet ID for the Visited Network to the mobile station which is the top 64 bits in the IPv6 addressing scheme. The subnet ID and the interface identifier combine to provide the mobile station with a Care-of-Address (COA). The Care-of-Address (COA) is a global unique IPv6 address for the mobile station. Once the mobile station has acquired a Care-of-Address (COA), the mobile station can then communicate on the Visited Network, or Foreign Network, and with its Home Network. In order for the previously described message call flow for Mobile IPv6 to operate, the mobile station must already know its Home Address (HoA) and Home Agent (HA) address. This prevents the Home Network from assigning or allocating IP addresses dynamically within the mobile station, including changing IP addresses for mobile stations, Home Agents, and other network nodes.

In order to achieve dynamic addressing within a Home Network for Mobile IPv6, the present invention provides an enhancement to the Mobile IPv6 protocol. The enhancement consists of two additional option messages, a Type 7 and a Type 8 message, to provide a Router Solicitation message for acquiring HA and HoA information and a Router Advertisement for providing HA and HoA information data.

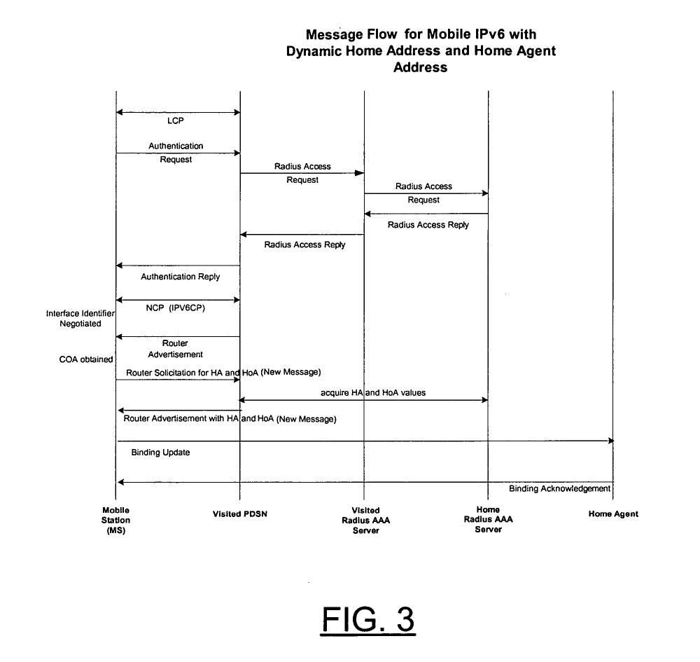

Referring now to FIG. 3, a control flow diagram is provided which illustrates message flow for Mobile IPv6 capable of providing Home Address and Home Agent address data for information dynamically. FIG. 3 provides a call flow diagram which builds upon the call flow diagram provided in FIG. 2. However, unlike the call flow diagram in FIG. 2 which relies upon pre-provisioned HA address and HoA data for the mobile station and the Care-of-Address (COA) for the mobile station for updating the binding in the Home Network, the call flow diagram in FIG. 3 provides for acquiring a Home Address (HoA) and Home Agent (HA) address for the mobile station which may be used for the binding update in the Home Network with the Care-of-Address (COA) obtained for the Foreign Network. After the Care-of-Address (COA) is obtained for the mobile station in the or Visited Network by the Visited PDSN, the mobile station may send a Router Solicitation message which requests a Home Address (HoA) and/or Home Agent (HA) address for the mobile station. The Visiting Network acquires Home Address (HoA) and/or Home Agent (HA) address data from the Home Network, and the HA and HoA data may be dynamically assigned by the Home Network at the time it is requested by the Visiting Network. The dynamically assigned Home Address (HoA) and/or Home Agent (HA) address data may be provided from the Visiting PDSN to the mobile station using a Router Advertisement message including Home Address (HoA) and/or Home Agent (HA) address data.

Once the mobile station has been acquired the Home Address (HoA) and/or Home Agent (HA) address data, the mobile station will provide a binding update to the Home Network with its Care-of-Address (COA) as obtained from the Visited Network can be dynamically acquired Home Address (HoA) and/or Home Agent (HA) address data it has acquired from the Home Network through the Visited Network using the enhanced Router Solicitation and Router Advertisement messages. By waiting to update the binding until after a dynamically assigned HA and HoA have been assigned, the mobile station is able to update a binding for its Care-of-Address (COA) without having to know the HA and HoA for the mobile station prior to booting up in the Foreign Network.

Where the Foreign Network and the Home Network already have a roaming agreement in place, the Visited AAA would know how to contact the Home AAA for acquiring the HA address and HoA. For example, when a mobile station tries to authenticate in a Foreign Network such as in the Verizon network, the mobile station may provide its Sprint user information to a Visited AAA of the Foreign Network which would be able to contact the Home AAA for Sprint to obtain an HA address and an HoA for the mobile station. If no roaming agreement is in place, either the roaming mobile station may not be able to communicate using the Foreign Network or the Visited AAA could acquire information for contacting the Home AAA such as though a Home Network access point for accepting HA address and HoA Mobile IPv6 requests or using a AAA registry.

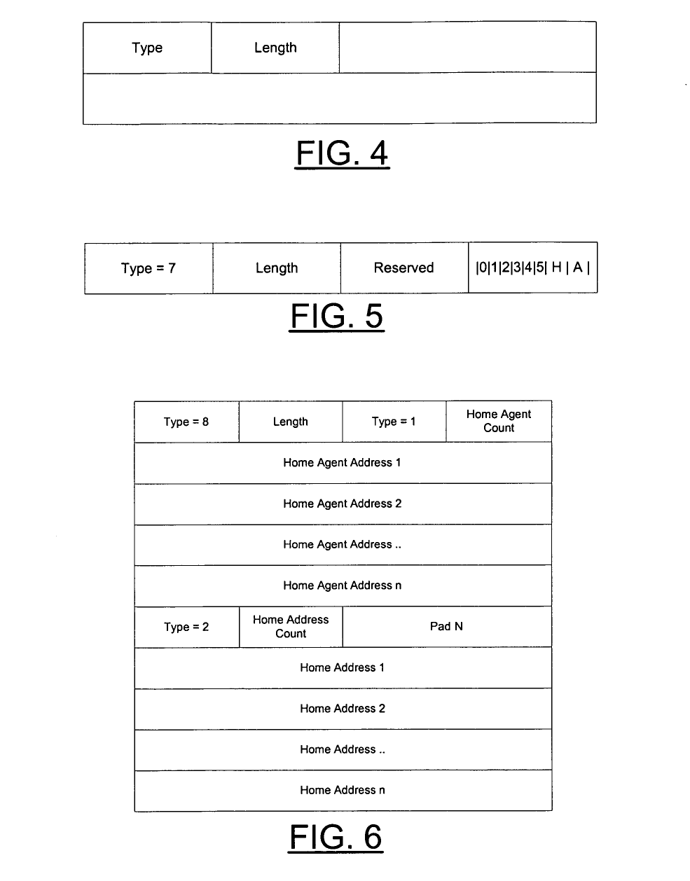

FIG. 4 defines the standard option format for Mobile IPv6 option messages. As shown in FIGS. 5 and 6, respectively, the present invention provides a Type 7 Router Solicitation message and a Type 8 Router Advertisement message within the existing Mobile IPv6 protocol framework. Router Solicitation and Router Advertisement messages are defined by RFC 2461, entitled Neighbor Discovery for IP Version 6 (IPv6) by Narten et al. (December 1998), the contents of which are fully-incorporated herein by reference. The Type 7 Router Solicitation message includes a length field, a reserved field, and an 8-bit field defined by 0, 1, 2, 3, 4, 5, H and A. If the H bit is set, the Type 7 Router Solicitation message from the mobile station is requesting a Home Address (HoA). If the A bit is set in the Type 7 Router Solicitation message the mobile station is requesting a Home Agent (HA) address. If both the H and A bits are set, the mobile station is requesting both a Home Address (HoA) and a Home Agent (HA) address. The length field is the length of the option in octets. The reserved field is reserved for future use.

The modified Router Advertisement message, indicated as a Type 8 option message, includes a length field, a type field set to 1, a Home Agent count field, and subsequent Home Agent (HA) address data fields 1, 2, . . . n corresponding to the Home Agent count. The Type 8 Router Advertisement message also includes a type field set to 2, a Home Address count field, and a Pad N field with subsequent Home Address data fields 1, 2, . . . n corresponding to the Home Address count. The length field is the length of the option in octets. The reserved field is reserved for future use. The Home Agent count is a count of the 128-bit Home Agent (HA) addresses. The Home Address count is the count of 128-bit home addresses. If the type field is set to 1, at least one Home Agent address is included. If the type field is set to 2 at least one Home Address (HoA) is included. The Home Address count and Home Agent count fields provide the Type 8 Router Advertisement message the ability to provide multiple Home Agent addresses and multiple Home Addresses to the mobile station. For example, for administrative reasons the Home Network may have conditions where the Home Agent may be down, permitting the mobile station the ability to contact a secondary Home Agent.

The enhancement to the Mobile IPv6 protocol standard only requires changes to the Mobile Station, the Target PDSN, and the Serving PDSN. Intermediate PDSNs, referred to as routers, do not need to be modified to understand the Type 7 and Type 8 messages because intermediate PDSNs, or routers, pass the messages forward to the final destination without interpreting the data passed by the router to the final destination. Further, network nodes such as registries may be used to handle static/pre-provisioned and dynamic Home Addresses (HoA) and Home Agent (HA) addresses for mobile stations. For example, a Home Network may continually update its assigned HA and HoA for a mobile station on a registry which may be accessed by a Foreign Network. In such a manner, a Foreign Network may be able to acquire the HA and HoA for a mobile station dynamically, and the Home Network may be able to use static and/or dynamic addressing for mobile stations, Home Agents, and network nodes. Registries may be associated with a particular Home Network or may be third-party network nodes providing an addressing index and storage service for a Home Network.

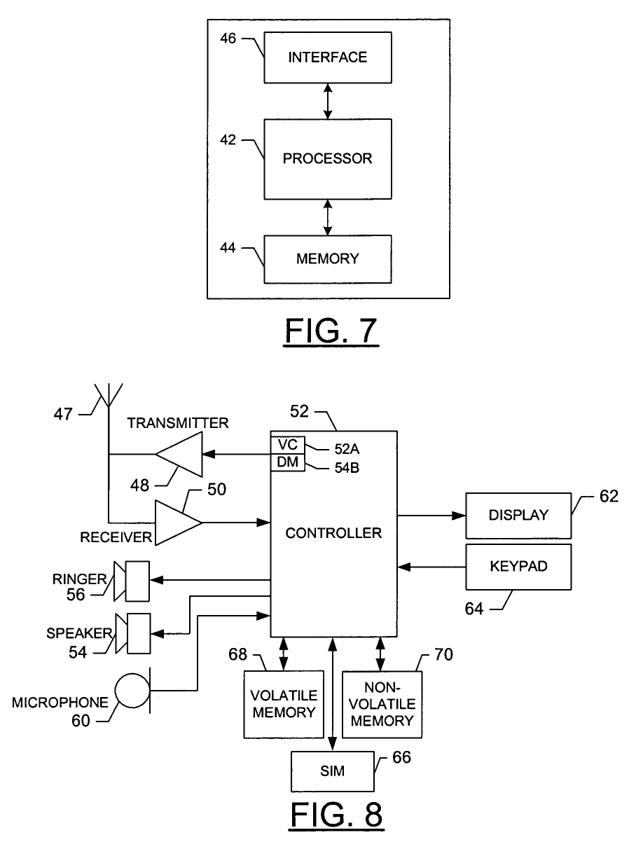

Reference is now made to FIG. 7, which illustrates a block diagram of an entity capable of operating in accordance with dynamic HA address and HoA establishment of one embodiment of the present invention. As shown, the entity capable of operating in accordance with dynamic HA address and HoA establishment can generally include a processor, controller, or the like 42 connected to a memory 44. The memory 44 can include volatile and/or non-volatile memory and typically stores content, data, or the like. For example, the memory 44 typically stores computer program code such as software applications or operating systems, information, data, content, or the like for the processor 42 to perform steps associated with operation of the entity in accordance with embodiments of the present invention. Also, for example, the memory 44 typically stores content transmitted from, or received by, the network node. Memory 44 may be, for example, random access memory (RAM), a hard drive, or other fixed data memory or storage device. Where the entity provides wireless communication, such as a CDMA mobile network, the processor 42 may operate with a wireless communication subsystem (not shown), such as a cellular transceiver. The entity may further include at least one interface 46, such as a network interface, a radio transceiver, or other means for transmitting and/or receiving data, content or the like. The interface 46 may be connected to the processor 42. One or more processors, memory, storage devices, and other computer elements may be used in common by a computer system and subsystems, as part of the same platform, or processors may be distributed between a computer system and subsystems, as parts of multiple platforms.

FIG. 8 illustrates a functional diagram of a mobile device, or mobile station (MS) capable of operating in accordance with dynamic HA address and HoA establishment of an embodiment of the present invention. It should be understood, that the mobile device illustrated and hereinafter described is merely illustrative of one type of mobile station that would benefit from the present invention and, therefore, should not be taken to limit the scope of the present invention or the type of devices which may operate in accordance with the present invention. While several embodiments of the mobile device are hereinafter described for purposes of example, other types of mobile stations, such as portable digital assistants (PDAs), pagers, laptop computers, and other types of voice and text communications systems, can readily be employed to function with the present invention.

The mobile device includes an antenna 47, a transmitter 48, a receiver 50, and a controller 52 that provides signals to and receives signals from the transmitter 48 and receiver 50, respectively. These signals include signaling information in accordance with the air interface standard of the applicable cellular system, such as a pilot channel of a CDMA network, and also user speech and/or user generated data, such as transmitted by traffic channels of a CDMA network. In this regard, the mobile device can be capable of operating with one or more air interface standards, communication protocols, modulation types, and access types. More particularly, the mobile device can be capable of operating in accordance with any of a number of second-generation (2G), 2.5G and/or third-generation (3G) communication protocols or the like. For example, the mobile device may communicate according to the CDMA 2000 standard and the Mobile IPv6 protocol standard. Additionally, for example, the mobile device may be capable of operating in accordance with 2G wireless communication protocols IS-136 (TDMA), GSM and IS-95 (CDMA), 2.5G wireless communication protocols such as GPRS and/or Enhanced Data GSM Environment (EDGE), and/or 3G wireless communication protocols such as Universal Mobile Telephone System (UMTS) network employing Wideband Code Division Multiple Access (WCDMA) radio access technology. Also, for example, the mobile device can also be capable of operating in accordance with enhanced 3G wireless communication protocols such as 1XEV-DO (TIA/EIA/1S-856) and 1XEV-DV. Further, for example, the mobile device can be capable of operating in accordance with any of a number of different wireless networking techniques, including WLAN techniques such as IEEE 802.11, WiMAX techniques such as IEEE 802.16 or the like.

It is understood that the controller 52, such as a processor or the like, includes the circuitry required for implementing the video, audio, and logic functions of the mobile device. For example, the controller may be comprised of a digital signal processor device, a microprocessor device, and various analog to digital converters, digital to analog converters, and other support circuits. The control and signal processing functions of the mobile device are allocated between these devices according to their respective capabilities. The controller 52 thus also includes the functionality to convolutionally encode and interleave message and data prior to modulation and transmission. The controller 52 can additionally include an internal voice coder (VC) 52A, and may include an internal data modem (DM) 52B. Further, the controller 52 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile device may also comprise a user interface such as including a conventional earphone or speaker 54, a ringer 56, a microphone 60, a display 62, all of which are coupled to the controller 52. The user input interface, which allows the mobile device to receive data, can comprise any of a number of devices allowing the mobile device to receive data, such as a keypad 64, a touch display (not shown), a microphone 60, or other input device. In embodiments including a keypad, the keypad can include the conventional numeric (0-9) and related keys (#, *), and other keys used for operating the mobile device and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile device can also include memory, such as a subscriber identity module (SIM) 66, a removable user identity module (R-UIM) (not shown), or the like, which typically stores information elements related to a mobile subscriber. In addition to the SIM, the mobile device can include other memory. In this regard, the mobile device can include volatile memory 68, as well as other non-volatile memory 70, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile device. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application, such as a software program or modules for an application, such as to implement a dynamic HA address and HoA establishment embodiment of the present invention, and may store an update for computer program code for the mobile device.

One of ordinary skill in the art will recognize that the present invention may be incorporated into hardware and software systems and subsystems, combinations of hardware systems and subsystems and software systems and subsystems, and incorporated into network systems and mobile stations thereof. In each of these systems and mobile stations, as well as other systems capable of using a system or performing a method of the present invention as described above, the system and mobile station generally may include a computer system including one or more processors that are capable of operating under software control to provide the techniques described above, including establishing dynamic HA addresses and HoAs using the Mobile IPv6 protocol.

Computer program instructions for software control for embodiments of the present invention may be loaded onto a computer or other programmable apparatus to produce a machine, such that the instructions which execute on the computer or other programmable apparatus create means for implementing the functions described herein, such as a mobile station employing a Mobile IPv6 protocol, enhanced as provided herein, to use Type 7 and Type 8 messages for requesting and providing home addressing for the mobile station. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions described herein, such as a method for establishing dynamic HA addresses and HoAs using the Mobile IPv6 protocol. It will also be understood that each block or element, and combinations of blocks and/or elements, can be implemented by hardware-based computer systems, software computer program instructions, or combinations of hardware and software which perform the specified functions or steps of establishing dynamic home addressing.

Herein provided and described are improved systems and methods for establishing dynamic Home Agent (HA) addresses and Home Addresses (HoA) for mobile stations operating on Foreign Networks according to the Mobile IPv6 standard, thereby providing the ability to dynamically assign IP addresses for mobile stations within a Home Network rather than using static or pre-provisioned IP addresses. The present invention provides new Type 7 Router Solicitation and Type 8 Router Advertisement messages to modify the existing Mobile IPv6 standard. The Type 7 and Type 8 messages enhance Mobile IPv6 to permit a mobile station in a Foreign Network to obtain through the Foreign Network a dynamically assigned Home Agent (HA) address and Home Address (HoA) from the Home Network for the mobile station.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method of establishing dynamic home addressing for a mobile device, comprising the steps of:
establishing communications in a foreign network;
sending an initiation message for home addressing data to a first network node of the foreign network; and
receiving home addressing data from a second network node of the foreign network.

2. The method of claim 1, wherein the first network node and the second network node are the same network node on the foreign network.

3. The method of claim 1, wherein at least one of the steps of establishing communications and sending an initiation message comprises the step of transmitting home network data to the foreign network.

4. The method of claim 1, wherein said step of sending an initiation message comprises the step of providing a request for at least one of a Home Agent (HA) address and a Home Address (HoA) and said step of receiving home addressing data comprises the step of receiving at least one of a Home Agent (HA) address and a Home Address (HoA).

5. The method of claim 1, wherein said step of establishing communications is performed according to the Mobile IPv6 standard.

6. The method of claim 1, wherein said step of sending an initiation message comprises the step of sending a Router Solicitation message and wherein said step of receiving home addressing data comprises the step of receiving a Router Advertisement message including the requested home addressing data.

7. The method of claim 6, wherein the Router Solicitation message includes a Type 7 message and the Router Advertisement message includes a Type 8 message.

8. The method of claim 1, wherein said step of establishing communications comprises the step of receiving a Care-of-Address (COA) for operation in the foreign network.

9. A method of establishing dynamic home addressing for mobile communications, comprising the steps of:
establishing communications with a mobile station in a foreign network;
receiving an initiation message for home addressing data from the mobile station at a network node of the foreign network;
acquiring home addressing data for the mobile station; and
transmitting home addressing data from the network node to the mobile station.

10. The method of claim 9, wherein said step of establishing communications is performed between the mobile station and the network node.

11. The method of claim 9, wherein said step of acquiring home addressing data comprises the step of communicating between the foreign network and a home network for the mobile station.

12. The method of claim 9, wherein said step of acquiring home addressing data comprises the step of communicating between the foreign network and a home addressing registry populated by a home network for the mobile station.

13. The method of claim 9, wherein at least one of the steps of establishing communications and receiving an initiation message comprises the step of receiving home network data from the mobile station.

14. The method of claim 9, wherein said step of sending an initiation message comprises the step of providing a request for at least one of a Home Agent (HA) address and a Home Address (HoA) and said step of transmitting home addressing data comprises the step of transmitting at least one of a Home Agent (HA) address and a Home Address (HoA).

15. The method of claim 9, wherein said step of establishing communications is performed according to the Mobile IPv6 standard.

16. The method of claim 9, wherein said step of sending an initiation message comprises the step of sending a Router Solicitation message and wherein said step of transmitting home addressing data comprises the step of transmitting a Router Advertisement message including the requested home addressing data.

17. A system capable of establishing dynamic home addressing, comprising:
a home network;
a mobile station associated with said home network; and
a foreign network wirelessly communicable with said mobile station and capable of dynamically providing home addressing data to said mobile station.

18. The system of claim 17, wherein said mobile station is capable of transmitting Type 7 home addressing request messages to said foreign network and receiving Type 8 home addressing data messages from said foreign network.

19. The system of claim 18, wherein said foreign network comprises an enhanced network node capable of receiving Type 7 home addressing request messages and transmitting Type 8 home addressing data messages

20. The system of claim 19, wherein said enhanced network node comprises a PDSN operating according to Mobile IPv6 enhanced to receive Type 7 home addressing request messages and transmit Type 8 home addressing data messages.

21. The system of claim 17, wherein said home network comprises a network node capable of dynamically providing home addressing data for said mobile station to said foreign network.

22. The system of claim 17, further comprising a home addressing registry communicable with said home network and said foreign network and capable of receiving home addressing data for said mobile station from said home network and providing said home addressing data for said mobile station to said foreign network.

23. A mobile station, comprising:
a controller;
an interface communicably connected to said controller, wherein said controller is capable of establishing communications with a network using said interface;
memory communicably connected to said controller and comprising a software application for acquiring home addressing data for the mobile station, wherein said software application comprises:
a first computer program code for causing said controller to send a request for home addressing data; and
a second computer program code for causing said controller to receive home addressing data.

24. The mobile station of claim 23, wherein said software application further comprises a third computer program code for transmitting said received home addressing data as a binding to a care-of-address for the mobile station.

25. The mobile station of claim 23, wherein said first computer program code comprises a fourth computer program code for embedding the request for home addressing data in a Router Solicitation message.

26. The mobile station of claim 23, wherein said second computer program code comprises a fifth computer program code for extracting the received home addressing data from a Router Advertisement message.

27. A network node, comprising:
a controller;
an interface communicably connected to said controller, wherein said controller is capable of establishing communications with a mobile station using said interface;
memory communicably connected to said controller and comprising a software application for providing home addressing data for the mobile station, wherein said software application comprises:
a first computer program code for causing said controller to receive a request for home addressing data;
a second computer program code for causing said controller to send a request for said requested home addressing data;
a third computer program code for causing said controller to receive home addressing data; and
a fourth computer program code for causing said controller to transmit said received home addressing data.

28. The network node of claim 27, wherein said first computer program code comprises a fifth computer program code for identifying the request for home addressing data in a Router Solicitation message.

29. The network node of claim 27, wherein said fourth computer program code comprises a sixth computer program code for embedding said received home addressing data in a Router Advertisement message.
